(19) United States
(12) Patent Application Publication
(10) Pub. No.: US 2001/0011819 A1
(43) Pub. Date: Aug. 9, 2001

(54) Book holder

(76) Inventor: Tadamasa Tao, Fukuoka (JP)

Correspondence Address: BROWDY AND NEIMARK, P.L.L.C., 624 NINTH STREET, NW, SUITE 300, WASHINGTON, DC, 20001-5303, US

(21) Appl. No.: 09/777,964

(22) Filed: Feb. 7, 2001

(30) Foreign Application Priority Data
Feb. 8, 2000 (JP) 2000/30185

(51) Int. Cl. B42D 7/00; B42D 9/00; B42D 17/00; B42D 3/00

(52) U.S. Cl. 281/45; 281/46; 281/42

(57) ABSTRACT

A book holder comprising a book receiving base, a pair of left and right page presser mounting portions arranged at left and right side peripheral portions of the book receiving base, each page presser mounting portion having a support member insertion hole extending in the vertical direction formed therein, a bottom stopper for supporting a bottom of a book, a pair of left and right page pressers mounted on the book receiving base in a substantially left-and-right symmetry, each page presser comprising a support member which is inserted into the support member insertion hole slidably and rotatably and a page pressing member which presses an opened page of the book, and fixing means for fixing the support members of the left and right page pressers at arbitrary positions. In such a book holder, a plurality of the page pressers are provided to each side of the book receiving base and the support members of a plurality of the page pressers at each side are inserted in the support member inserting holes such that the support members are vertically slidable and rotatable independently from each other.

### BACKGROUND OF THE INVENTION

(1) Field of the Invention

The present invention relates to a book holder, and more particularly to a book holder which allows a reader to turn each page of a book using a single hand even lying on a bed in a hospital or at home.

(2) Description of the Prior Art

Conventionally, there have been proposed various kinds of book holders for holding books thereon. One of such book holders is disclosed in Japanese Laid-open Utility Model Application 11773/1993.

To explain the constitution of such a book holder, a pair of page pressers is mounted on both left and right sides of a book receiving base on which a book is placed. The book receiving base is further provided with a bottom fixed stopper at a bottom thereof for supporting a bottom of the book placed on the book receiving base and a top slide stopper at a top thereof. The lower fixed stopper is provided with a lower pin extended from the bottom to the top at the central portion of the book receiving base so as to hold a central binding portion of the book in a page-opened state on the book receiving base. The slidable upper plate is also provided with an upper pin extended from the top to the bottom at the central portion of the book receiving base so as to hold the central binding portion of the book in a page-opened state on the book receiving base. Each page presser is comprised of a vertical support member and a horizontally-extending transparent page pressing member which is connected to an upper end of the support member. The support member is inserted into a hole formed on each side of the book receiving base in such a manner that the support member is slidable and rotatable relative to the hole and is fixedly secured at a desired position. Each transparent page pressing member is extended toward a central portion of the book receiving base in parallel with a book receiving surface of the book receiving base thus forming a page inserting gap between the page pressing member and the book receiving base. Further, a cylindrical pressure contact member made of an elastic material such as plastic is accommodated in each hole and the support member of the page presser is held by this cylindrical pressure contact member. Still further, the support member is provided with a protrusion which is engaged with an engaging portion formed in the hole at the time that the page presser is in use.

Due to such a constitution, after placing the book in a page-opened state, the lower pin is inserted into a bottom-side binding portion of the book and the upper pin is also inserted into an upper-side binding portion of the book. Then, the left and right page pressing members are lowered to press the left and right pages of the book while adjusting a pressing pressure to a suitable value. To turn the page, for example, an uppermost page on the left side of the book receiving base is pulled out from the left-side page inserting gap, then is turned and finally is inserted into the right-side page inserting gap.

The above-mentioned book holder, however, has following drawbacks.

When a reader lying on a bed reads a book in a turn-over posture as shown in FIG. 38, surfaces of opened pages are directed in a downward direction or in an inclined downward direction. In this case, in addition to a repulsive force generated by arcuate opened pages which tend to move in a page closing direction due to their resiliency, the page pressing members also receive a pressing force (a supporting force) generated by the weight of the pages per se and hence, a strong concentrated pressure is applied to a distal end of each page pressing member. Accordingly, in the page turning operation, to pull out the page from the left-side page inserting gap or to insert the pulled-out page into the right-side page inserting gap, a large pulling force or a large inserting force becomes necessary and hence, there exists a possibility that the page is torn or damaged or a stand which mounts the book holder thereon is turned down.

Further, in the conventional book holder, the press members are provided at fixed positions and hence, the press members cannot cope with the change of the size of the book mounted on the book receiving base.

Further, in the conventional book holder, the cylindrical pressure contact member made of the elastic material such as rubber is accommodated in the hole. Alternatively, when the support member is made of a metal bar, a magnet is accommodated in the hole. In these cases, to ensure a stable retaining force or a large retaining force to retain the support members, the constitution of the hole forming portions and the support members must be large-sized. Particularly, in the fitting engagement of the support members with the cylindrical pressure contact members, there exists a problem that it is difficult to obtain the stable retaining force even when the resilient material which constitutes the cylindrical pressure contact members is worn. On the other hand, to maintain a fixed retaining force, in pulling out the page presser from the hole or in inserting the page presser into the hole, when such an operation is performed by gripping the page presser using only a single hand, the book receiving base is swung so that it is difficult to perform the pulling-out and the inserting manipulation.

Further, in the conventional book holder, to firmly mount the book on the book holder, that is, to prevent the book mounted on the book holder from being displaced in the up-and-down direction or in the left-and-right direction, the upper and lower pins which are fixedly mounted on the top side and the bottom side of the book receiving base are inserted into a space defined between the pages at a binding portion of the book after opening the book at an intermediate portion with respect to the thickness of the book. In this case, since the upper pin and the lower pin are fixedly secured to the slidable upper plate and the bottom fixed stopper, when the thickness of pages of the book is thin, the upper and lower pins are loosely brought into contact with the binding portion of the book so that the firm mounting of the book on the book receiving base becomes less than optimal.

On the other hand, when the thickness of the pages of the book is excessively thick, it becomes difficult to insert the pins into the space defined between the pages at the binding portion of the book. Particularly, when a book having a thick (hard) cover is mounted on the book receiving base, since a binding portion of the book is not sunk, when the pins are fixedly secured to the slidable upper plate and the bottom fixed stopper, it is impossible to insert the pins into the space defined between the pages at the binding portion of the book.

The present invention has been made to overcome these drawbacks and it is an object of the present invention to provide a book holder which can allow a reader to easily turn each page of a book using a single hand in any posture including a lying posture.

It is another object of the present invention to provide a book holder which can substantially allow a book of any size to be mounted on a book receiving base without enlarging the size of a book receiving base on which a book is mounted.

It is a still another object of the present invention to provide a book holder which can substantially allow a book of any thickness to be firmly mounted on a book receiving base using vertically slidable pins which are inserted into spaces defined between pages of the book at a binding portion of the book.

It is a still further object of the present invention to provide a book holder which can surely retain supporting members of page pressers in holes formed at both lateral sides of a book receiving base thus ensuring a stable page pressing force.

### SUMMARY OF THE INVENTION

According to a first aspect of the present invention, there is provided a book holder comprising a book receiving base forming a book mounting surface on an upper surface thereof, a pair of left and right page presser mounting portions which are respectively arranged at left and right side portions of the book receiving base, each page presser mounting portion having a support member insertion hole extending in the vertical direction formed therein, a bottom stopper for supporting a bottom of a book being mounted on a bottom portion of the book receiving base, the bottom stopper having a pin extending toward a top of the book receiving base at a central portion of the book receiving base, a pair of left and right page pressers arranged on the book receiving base in a substantially left-and-right symmetry, each page presser comprising a support member which is inserted into the support member insertion hole slidably in a vertical direction and rotatably and a page pressing member which has one end connected to an upper end of the support member and the other end extended toward a central portion of the book receiving base parallel with the book mounting surface of the book receiving base, and fixing means for fixing the support members of the left and right page presser at arbitrary positions in said holes, wherein the improvement is characterized in that a plurality of the page pressers are provided to each side of the book receiving base and the support members of a plurality of the page pressers at each side are inserted in the support member inserting hole such that the support members are vertically slidable and rotatable independently from each other.

According to a second aspect of the present invention, in the above-mentioned constitution, a plurality of the page pressers mounted on each side of the book receiving base are constituted by two page pressers, the support member inserting hole is constituted by two support member inserting holes, and the support members of the two page pressers are respectively slidably and rotatably inserted into the two support member inserting holes.

According to a third aspect of the present invention, in the above-mentioned constitution, a plurality of the page pressers arranged at each side of the book receiving base are constituted by two page pressers, the support member inserting hole is constituted by a single support member inserting hole, the support members of the two page pressers form a concentric duplicate tube structure and the duplicate tube structure is slidably and rotatably inserted into the single support member inserting hole, and the two support members are slidable and rotatable from each other.

According to a fourth aspect of the present invention, in the above-mentioned constitution, both of a pair of the left and right page presser mounting portions which are respectively arranged at left and right side peripheral portions of the book receiving base are slidable relative to the book receiving base in a lateral direction.

According to a fifth aspect of the present invention, in the above-mentioned constitution, a cavity which is communicable with the hole is formed in each page presser mounting portion and resistant bodies and a biasing spring which resiliently brings the resistant bodies into slide contact with the support members of the page presser are accommodated in the cavity.

According to a sixth aspect of the present invention, in the above-mentioned duplicate tube structure, one of the support members is made of a rod and the other is made of a tube which concentrically surrounds the rod, a slit is formed in the rod, and a pressure contact element having a diameter larger than an outer diameter of the rod is disposed in the slid and is brought into pressure contact with an inner surface of the tube.

According to a seventh aspect of the present invention, in the above-mentioned constitution, the pin mounted on the bottom stopper is slidable in a direction toward or away from the book receiving surface of the book receiving base so as to adjust a height thereof from the book receiving surface.

According to an eighth aspect of the present invention, a top stopper is provided to a top central portion of the book receiving base, the top stopper is slidable relative to the book receiving base in a direction toward or away from the bottom stopper, and a pin is mounted on the top stopper such that the pin is slidable in a direction toward or away from the book receiving surface of the book receiving base so as to adjust a height thereof from the book receiving surface.

According to a ninth aspect of the present invention, in the above-mentioned constitution, a finger engaging tab is formed on an outer side of each page presser mounting portion.

According to a tenth aspect of the present invention, in the above-mentioned constitution, at least a portion of each page pressing member is made of a transparent material.

### BRIEF EXPLANATION OF THE DRAWINGS

FIG. 1 is plan view of a book holder according to an embodiment of the present invention.

FIG. 2 is a front view of the book holder as viewed in an arrow direction taken along a line I-I of FIG. 1.

FIG. 3 is a transverse cross-sectional view of the book holder as viewed in an arrow direction taken along a line II-II of FIG. 1.

FIG. 4 is a longitudinal cross-sectional view of the book holder as viewed in an arrow direction taken along a line III-III of FIG. 1.

FIG. 5 is a back plan view of the book holder according to the embodiment.

FIG. 6 is a schematic plan view of a page presser mounting portion according to the first embodiment of the present invention.

FIG. 7 is a schematic cross-sectional view taken along a line IV-IV of FIG. 6.

FIG. 8 is a plan view of a page presser mounting portion.

FIG. 9 is a front view of the page presser mounting portion.

FIG. 10 is a right side view of the page presser mounting portion.

FIG. 11 is a plan view showing a page presser mounting portion according to a modification of the present invention.

FIG. 12 is a front view showing the page presser mounting portion according to a modification of the embodiment.

FIG. 13 is an enlarged cross-sectional plan view of a page presser mounting portion showing a resistant body brought into contact with a support member.

FIG. 14 is an enlarged longitudinal cross-sectional plan view of the page presser mounting portion showing the resistant body brought into contact with the support member.

FIG. 15 is a cross-sectional plan view of a page presser mounting portion according to a modification of the embodiment showing resistant bodies brought into contact with support members.

FIG. 16 is an enlarged longitudinal cross-sectional plan view of the page presser mounting portion according to the modification of the embodiment showing the resistant bodies brought into contact with the support members.

FIG. 17 and FIG. 18 are respectively enlarged cross-sectional views of the page presser mounting portion according to another modification of the embodiment showing a pressure contact element brought into pressure contact with the support member.

FIG. 19 is a longitudinal cross-sectional view showing a page presser mounting portion according to another modification of the embodiment.

FIG. 20 is an enlarged longitudinal cross-sectional view showing a slide structure of a top slide stopper.

FIG. 21 is an enlarged longitudinal cross-sectional view showing a pin slide structure of a bottom stopper or a top stopper.

FIG. 22 is an explanatory view showing a pin disposed in a space defined between opened pages of a book.

FIG. 23 is a longitudinal cross-sectional view of the book holder of the embodiment in an actual use.

FIG. 24 is a perspective view of the book holder of the embodiment in an actual use showing how an opened page is turned.

FIG. 25 to FIG. 37 are explanatory perspective views showing the manner of using the book holders according to the embodiment and the modification.

FIG. 38 to FIG. 40 are perspective views showing the book holder of the embodiment mounted on a stand in various applications.

FIG. 41 is a perspective view showing the book holder of the embodiment placed on a table.

### DETAILED DESCRIPTION OF THE PREFERRED EMBODIMENTS

[Embodiment]

Hereinafter, an embodiment of the present invention is explained in conjunction with attached drawings.

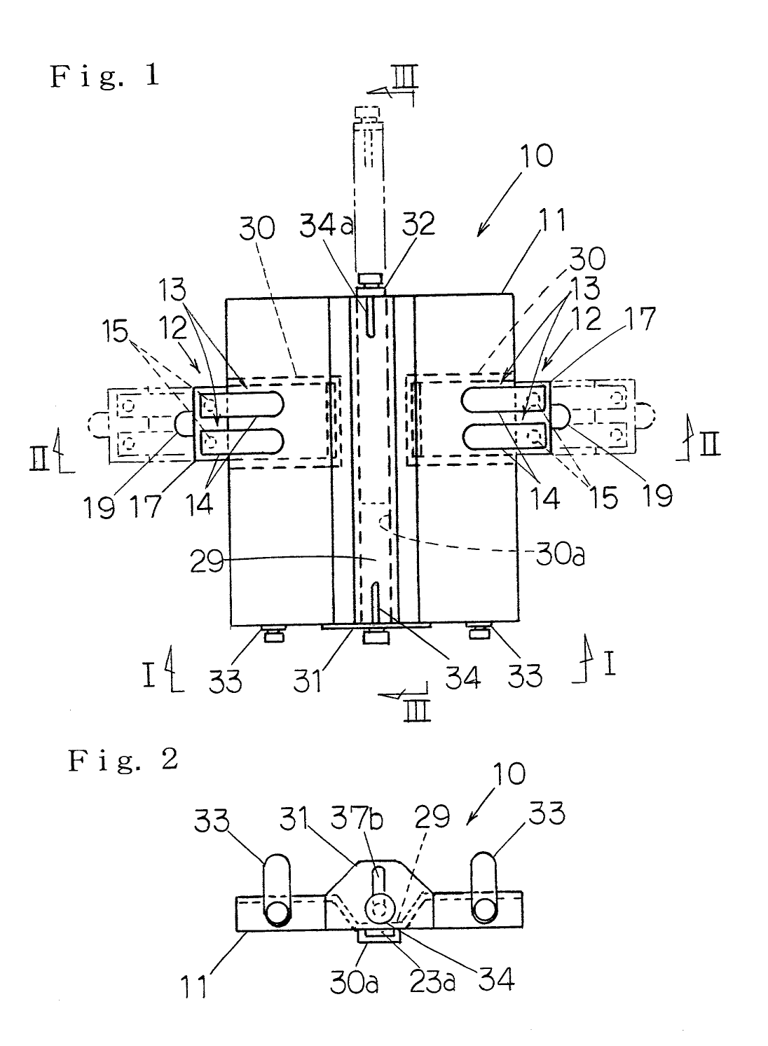

First of all, the entire constitution of a book holder according to this embodiment is explained in conjunction with FIG. 24 and FIG. 1 to FIG. 5.

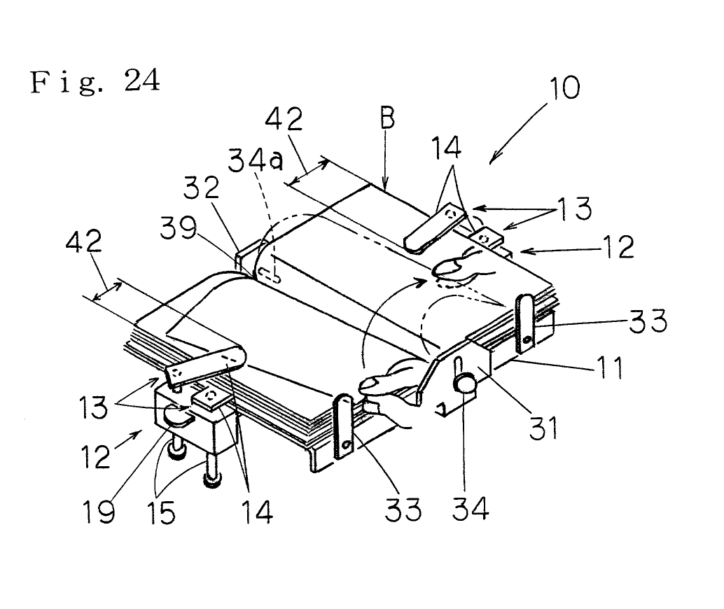

As shown in these drawings, left and right page pressers 13 are mounted on both left and right sides of a book receiving base 11 on which a book B is placed in an opened state. As can be clearly understood from FIG. 1 and FIG. 24, a plurality of (two in this embodiment) page pressers 13 are disposed at the left side of the book receiving base 11, while a plurality of (two in this embodiment) page pressers 13 are disposed at the right side of the book receiving base 11.

The book receiving base 11 is further provided with a bottom fixed stopper 31 at a bottom thereof for supporting a bottom of the book B placed on the book receiving base 11 and a top slide stopper 32 at a top thereof.

The bottom fixed stopper 31 is provided with a lower pin 34 extended from the bottom to the top at the central portion of the book receiving base 11 so as to hold a central binding portion 39 of the book B in a page-opened state on the book receiving base 11. In this embodiment, as explained later, the lower pin 34 is slidable in the direction toward and away from a book receiving surface of the book receiving base 11.

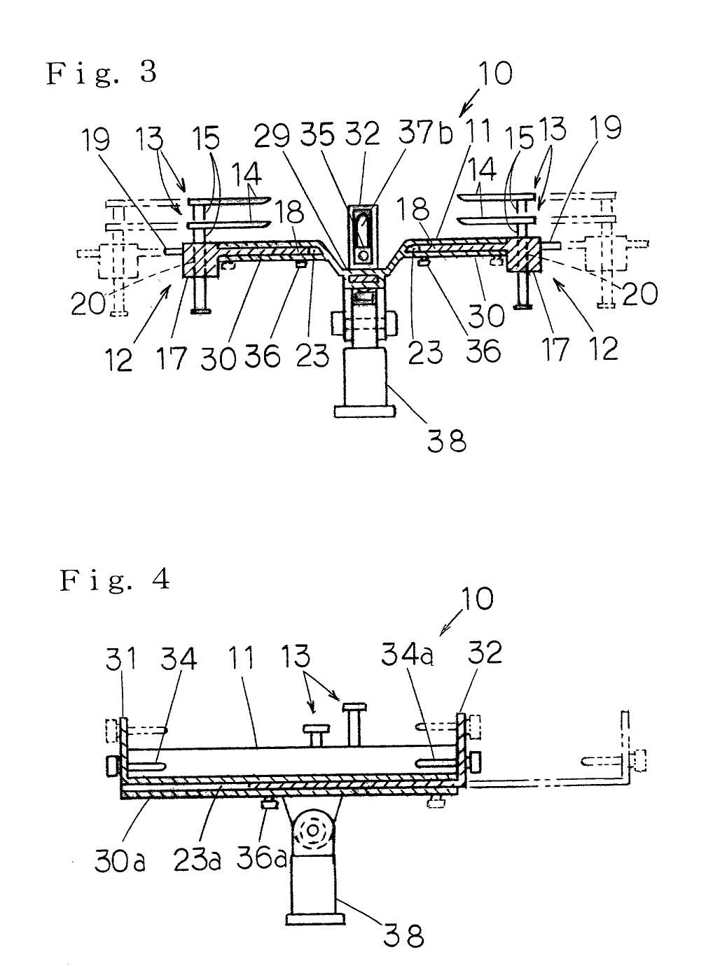

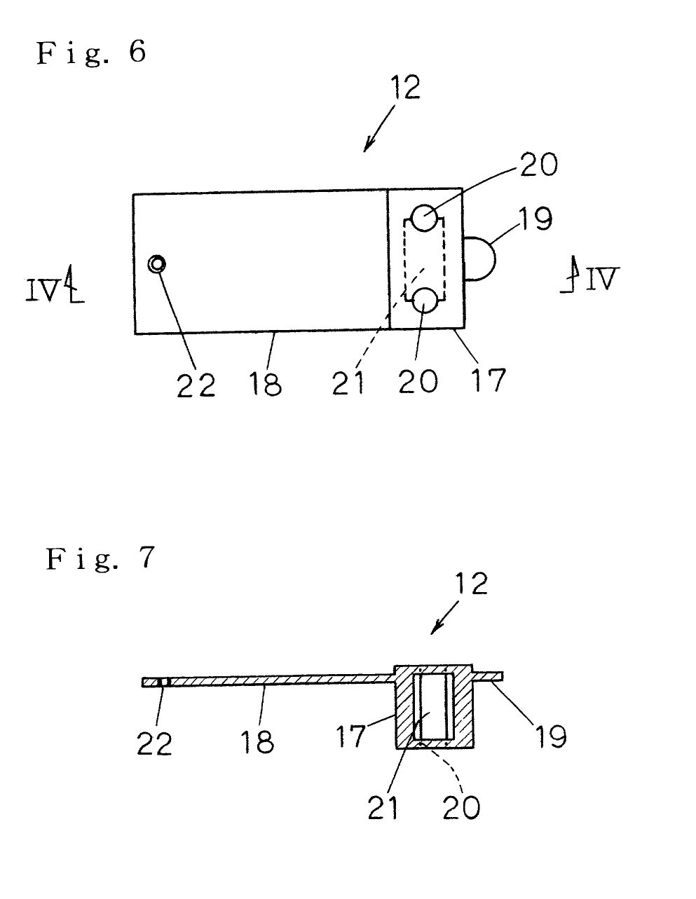

The top slide stopper 32 is also provided with an upper pin 34a extended from the top to the bottom at the central portion of the book receiving base 11 so as to hold the central binding portion 39 of the book B in an page-opened state on the book receiving base 11. Each page presser 13 is comprised of a vertical support member 15 and a horizontally-extending transparent page pressing member 14 which is connected to an upper end of the support member 15. To the left and right sides of the book receiving base 11, page presser mounting portions 12 are provided respectively. In each page presser mounting portion 12, as shown in FIG. 6 and FIG. 7, a plurality of (two in this embodiment) holes 20 are formed. As shown in FIG. 3 and FIG. 24, at each side of the book receiving base 11, respective support members 15 of two page pressers 13 are inserted in the corresponding holes 20 formed in the page presser mounting portion 12. The support members 15 are slidable in the axial direction and rotatable relative to the holes 20 and can be fixed at a desired position in the holes 20 by means of fixing means which will be explained later.

Further, the transparent page pressing members 14 are extended toward a central portion of the book receiving base 11 in parallel with the book receiving surface of the book receiving base 11 thus forming page inserting gaps between the page pressing members 14 and the book receiving base 11.

Still further, in this embodiment, the page presser mounting portions 12 are slidable in a lateral direction relative to the book receiving base 11 so that the page pressers 13 which are mounted on the page presser mounting portions 12 can be also moved in the lateral direction thus enabling the mounting of the book B of a large size on the book receiving base 11 as will be explained later in detail.

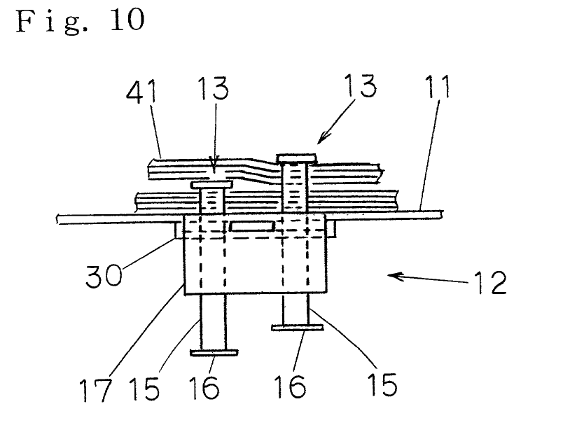

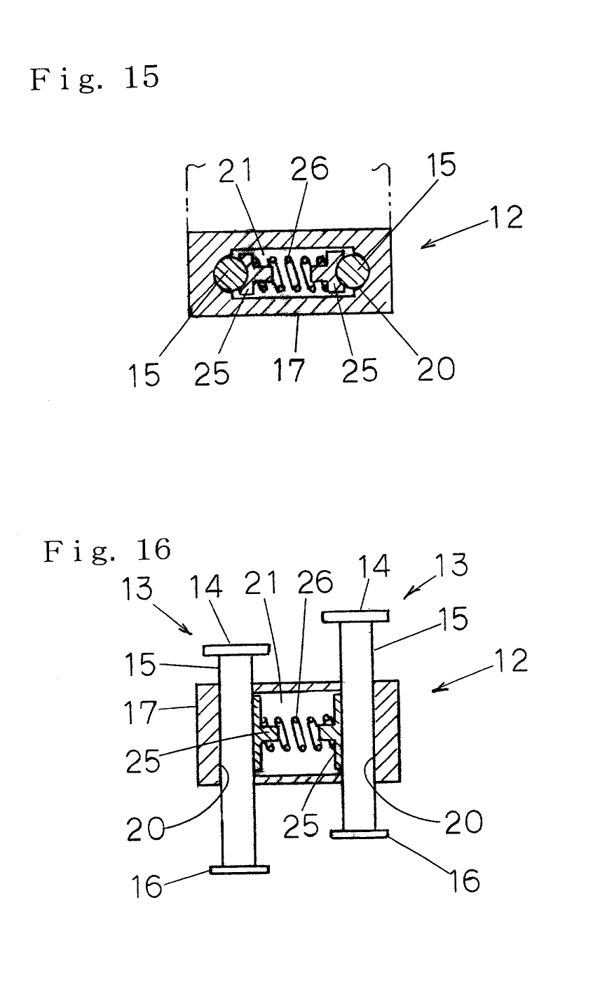

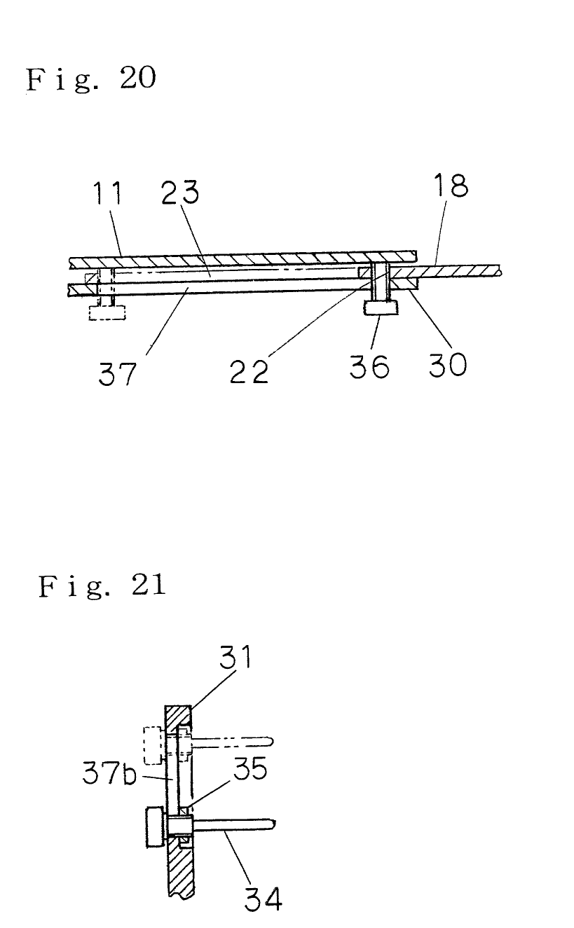

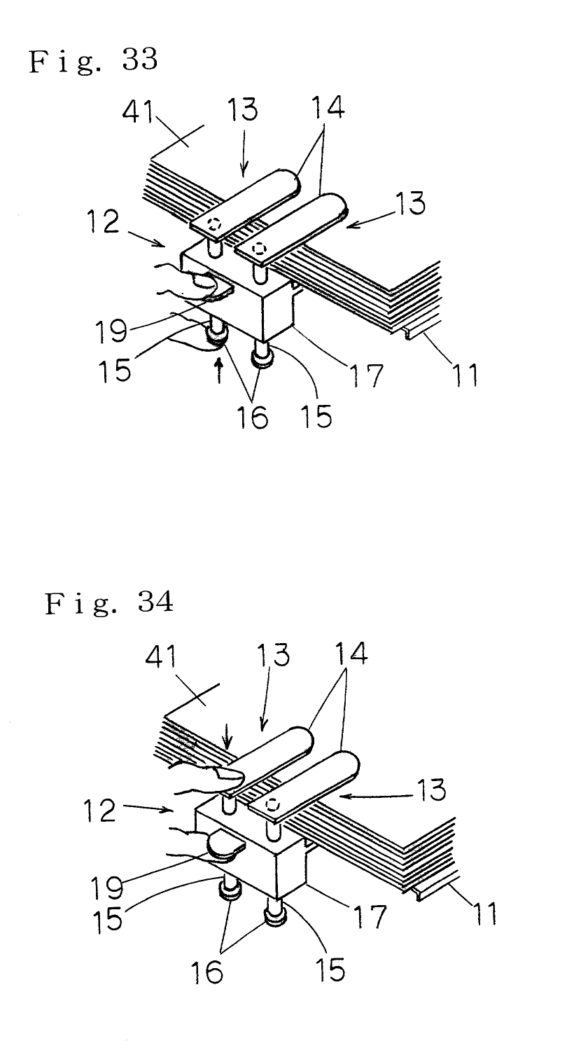

Then, the detailed constitution of respective components of the book holder 10 of this embodiment is explained hereinafter in conjunction with FIG. 24, FIG. 1 to FIG. 10, FIG. 15 to FIG. 18, FIG. 20 to FIG. 23, FIG. 33 and FIG. 34.

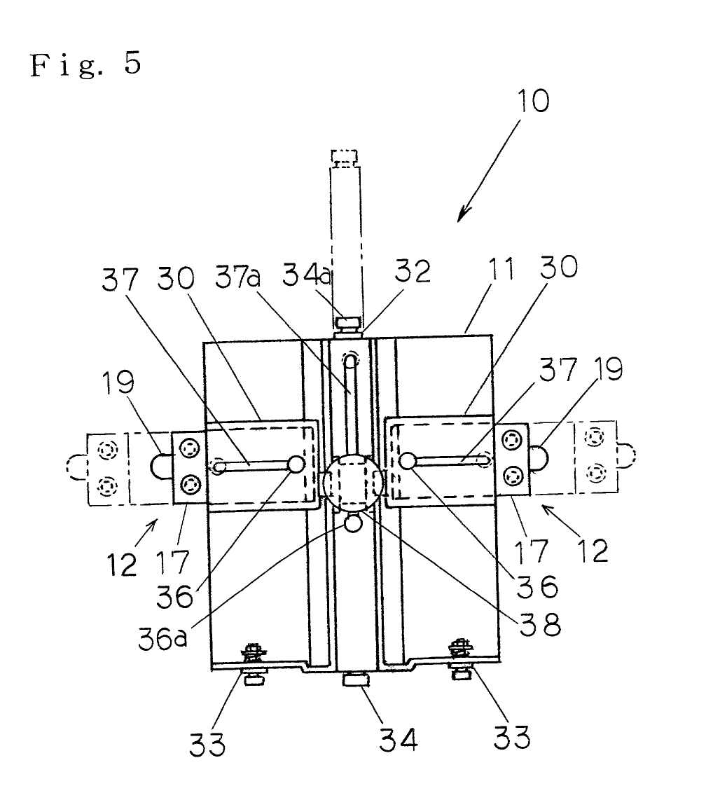

As shown in FIG. 1 to FIG. 5, guides 30 are integrally mounted on or are fixedly secured to a back surface of the book receiving base 11 at both left and right sides of the book receiving base 11 for forming laterally-extending slide spaces 23 therein. As shown in FIG. 6 and FIG. 7, the left and right page presser mounting portions 12 are comprised of hole forming portions 17 and slide plates 18 and these slide plates 18 are slidably inserted into the slide spaces 23. Due to such a constitution, the left and right page presser mounting portions 12 can be moved laterally. As shown in FIG. 5, the guides 30 which form such slide spaces 23 therein are respectively provided with elongated holes 37 extending in the left and right directions. Stop screws 36 are threaded into threaded holes 22 formed in the slide plates 18 by way of the elongated holes 37 formed in the guides 30 in which the slide spaces 23 are formed.

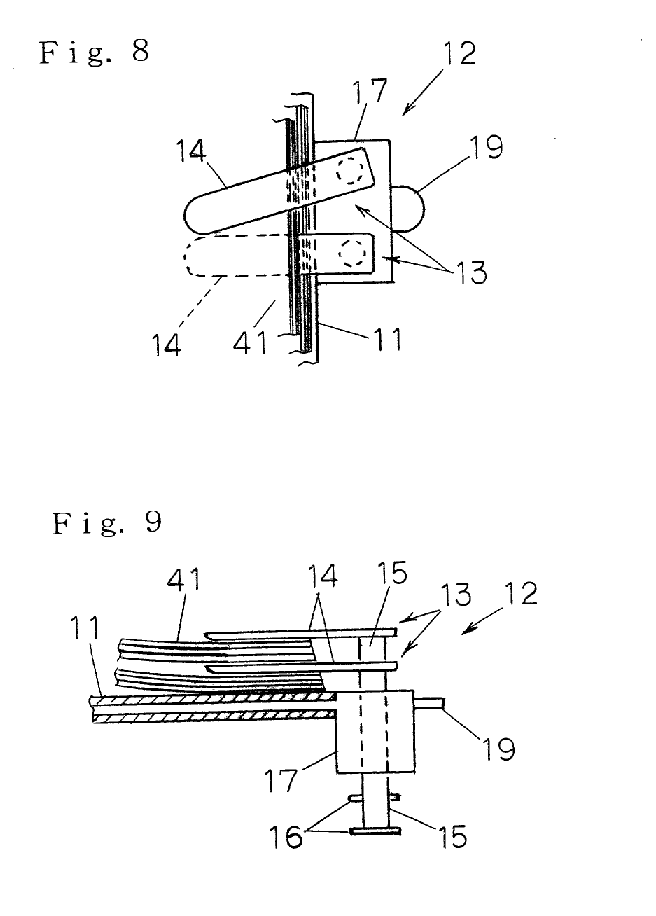

As shown in FIG. 6 and FIG. 7 which show the page presser mounting portion 12 in an enlarged form, in the hole forming portion 17, two holes 20 are formed as through-holes in a spaced apart manner in a longitudinal direction for mounting two page pressers 13 thereon (see FIG. 8 to FIG. 10). Further, the threaded hole 22 is formed in a distal portion of the slide plate 18.

Referring now to the page pressers 13, as shown in FIG. 3, each page presser 13 is substantially formed in an L-shape and is comprised of the laterally extending page pressing member 14 which has at least a distal portion thereof made of a transparent material partially or approximately wholly and the vertically extending support member 15 which has an upper end thereof connected to a proximal end of the page pressing member 14. As shown in FIG. 3, two support members 15 are mounted on the hole forming portion 17 of each page presser mounting portion 12 such that these support members 15 are inserted into the hole 20 formed in the hole forming portion 17. In the holes 20, the support members 15 are independently slidable and rotatable relative to the holes 20 and can be fixedly at an arbitrary position.

As shown in FIG. 6 and FIG. 7, the hole forming portion 17 is equipped with a finger engaging member 19 which facilitates the manipulation of the page pressers 13 as will be explained later. Further, a cavity 21 is formed in the inside of the hole forming portion 17 and two holes 20 which are formed as through holes are communicated with the cavity 21.

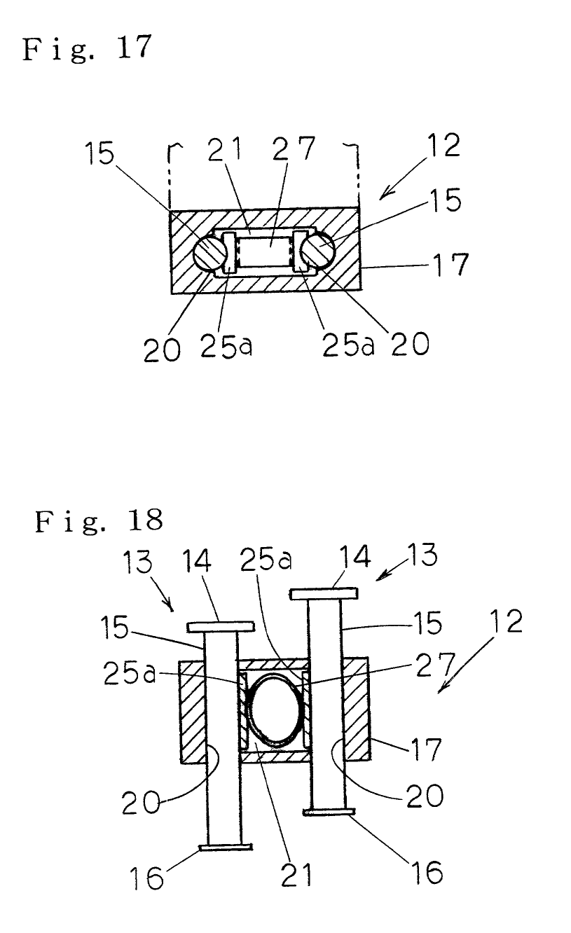

As shown in FIG. 15 and FIG. 16, in the inside of the cavity 21, for holding two support members 15 of the page pressers 13 in the holes 20, resistant bodies 25 which are pushed by a biasing spring 26 or the like is accommodated. To explain the structure of the hole forming portion 17 of the page presser mounting portion 12 in more detail, two holes 20 penetrate the hole forming portion 17 from the upper surface to the bottom surface of the hole forming portion 17 and these holes 20 are communicated with the cavity 21 defined inside the hole forming portion 17. The support members 15 of the page pressers 13 are inserted into these two holes 20 such that the support members 15 pass through the holes 20. Stoppers 16 having a width larger than the inner diameter of the holes 20 are fixedly mounted on the distal ends of the support members 15. As shown in FIG. 17 and FIG. 18, in the cavity 21 formed integrally and contiguously with two through-holes 20, the resistant bodies 25,25a which are brought into pressure contact with portions of outer peripheries of respective support members 15 and the biasing spring 26 or a leaf spring 27 which pushes these two resistant bodies 25, 25a in a biasing manner are mounted.

Returning back to the constitution of the book receiving base 11 again, as shown in FIG. 3 and FIG. 4, a recessed groove 29 is formed at the central portion of the book receiving base 11 and the recessed groove 29 extends between the top and the bottom of the book receiving base 11. The bottom fixed stopper 31 which has a raised portion being contiguous with the central recessed groove 29 is formed at the bottom side of the book receiving base 11. As shown in FIG. 21, an elongated hole 37b extending in the vertical direction is formed in a central portion of the bottom stopper 31 and a threaded pin 34 having a tab is slidably mounted in the elongated hole 37b and this pin 34 can be fixed at a desired position together with a nut 35. As shown in FIG. 1 and FIG. 2, at both left and right sides of the bottom portion of the book receiving base 11, rotary stoppers 33 are mounted. These rotary stoppers 33 are rotatable and can be fixed at a desired rotated position. These rotary stoppers 33 are provided for preventing a page disposed below and next to an opened page from pulled out together with the opened page.

On the back surface of the central portion of the book receiving base 11, as shown in FIG. 3 and FIG. 4, a longitudinally extending slide space 23a is formed in the guide 30a and this slide space 23a opens toward the top side of the book receiving base 11. Further, as shown in FIG. 5, on the back surface (outer surface) of the guide 30a, an elongated hole 37a is formed at a position substantially close to the top side of the book receiving base 11. A longitudinally elongated portion of the top slide stopper 32 is slidably accommodated in the inside of the slide space 23a. An L-shaped raised portion is provided to a rear portion of the top slide stopper 32. As shown in FIG. 3, an elongated hole 37b is formed in the raised portion in the vertical direction and a threaded pin 34a having a tab is mounted in the elongated hole 37b such that the pin 34a is slidable and is fixed at a desired position as shown in FIG. 21.

A slide portion of the top slide stopper 32 is provided with a threaded hole 22a. A stopper screw 36a is engaged with the threaded hole 22a through the elongated hole 37a. Then, as shown in FIG. 3 and FIG. 4, a strut 38 is mounted on an intermediate portion on the back surface of the central portion of the book receiving base 11.

Further, as shown in FIG. 24, page pressing margins 42 are formed on the left and right sides of the book receiving base 11. Here, when the page pressing margin 42 is excessively large, it is difficult to pull out the page from the page pressing member 14 of the page presser 13, while when the page pressing margin 42 is small, the page is liable to be easily removed from the page pressing member 14.

[Manner of Operation]

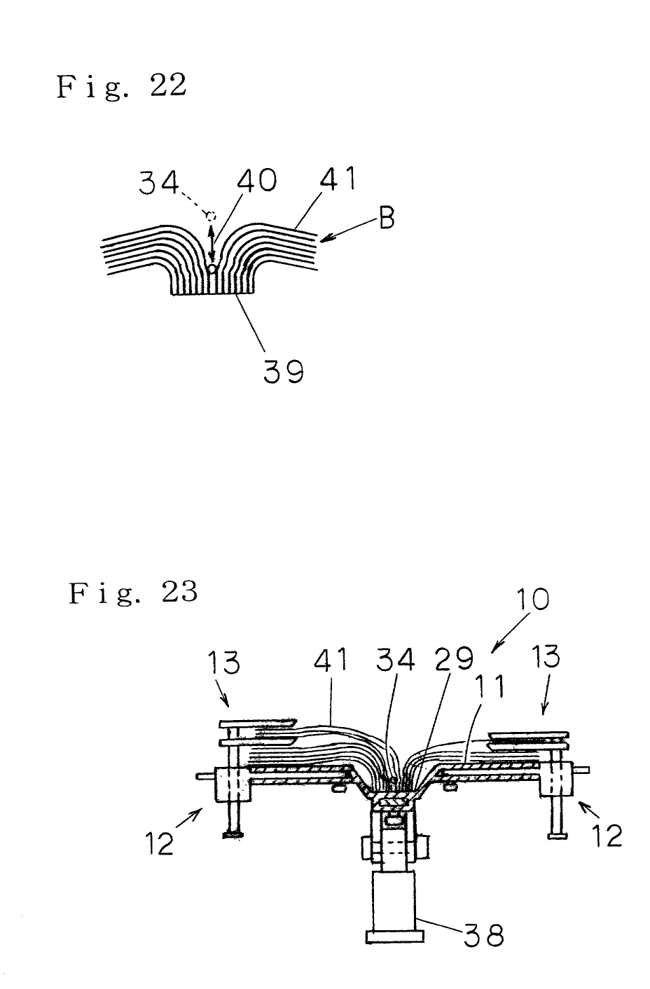

The manner of operation of the book holder 10 according to this embodiment of the present invention is hereinafter explained in conjunction with FIG. 8 to FIG. 10, FIG. 22 and FIG. 24.

As shown in FIG. 22 and FIG. 24, in the state that both page pressing members 14 of page pressers 13 are disposed outside the book receiving base 11 which is brought about by rotating both page pressers 13 outwardly, the book B is placed on the book receiving base 11 and intermediate pages of the book B are opened.

Subsequently, as shown in FIG. 22, the threaded pins 34, 34a which are disposed at the bottom and the top of the center portion of the book receiving base 11 in an opposed manner are pushed downwardly in an arrow direction 40 from above toward the binding portion 39 of the book B to fix the book B on the book receiving base 11.

Then, the page pressing members 14 of a plurality of page pressers 13 arranged in the longitudinal direction at each side of the book receiving base 11 are rotated and extended toward the center of the book receiving base 11 and then are pushed downwardly to press the opened pages of the book B.

To be more specific, as shown in FIG. 8 to FIG. 10, the page pressing member 14 of the front-side page presser 13 is inserted into a gap formed between a cover of the book B and a page next to the cover or a gap formed between arbitrary two pages among a plurality of pages and then the page presser 14 is directed toward the central portion of the book receiving plate 11. Then, this page pressing member 14 is pushed down to press surface of the pages with a given force. Then, the page pressing member 14 of the rear-side page presser 13 is extended toward the central portion of the book receiving base 11 laterally or slightly downwardly inclined direction and is pushed downwardly to press the surface of the opened page 41 with a light pressure.

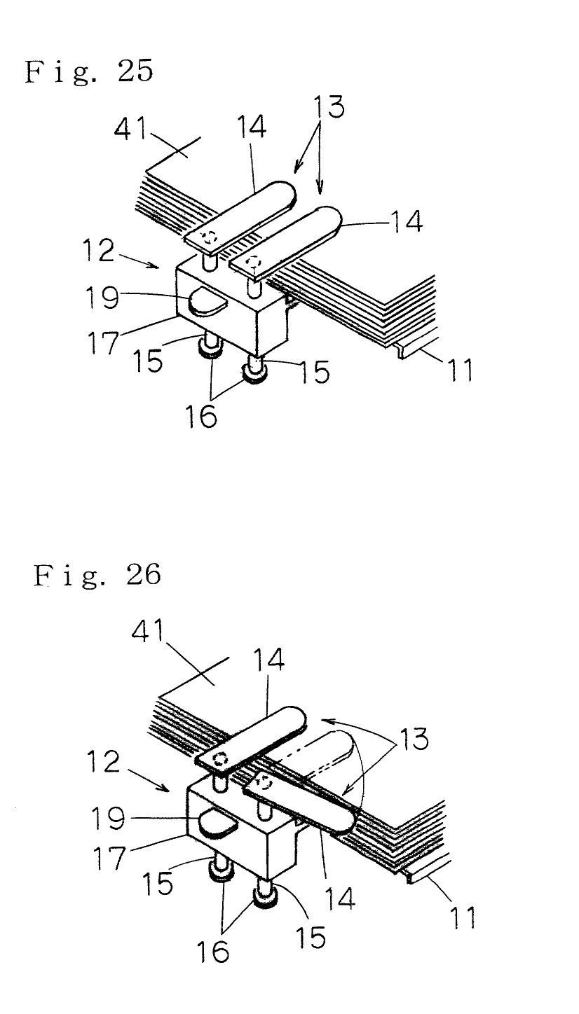

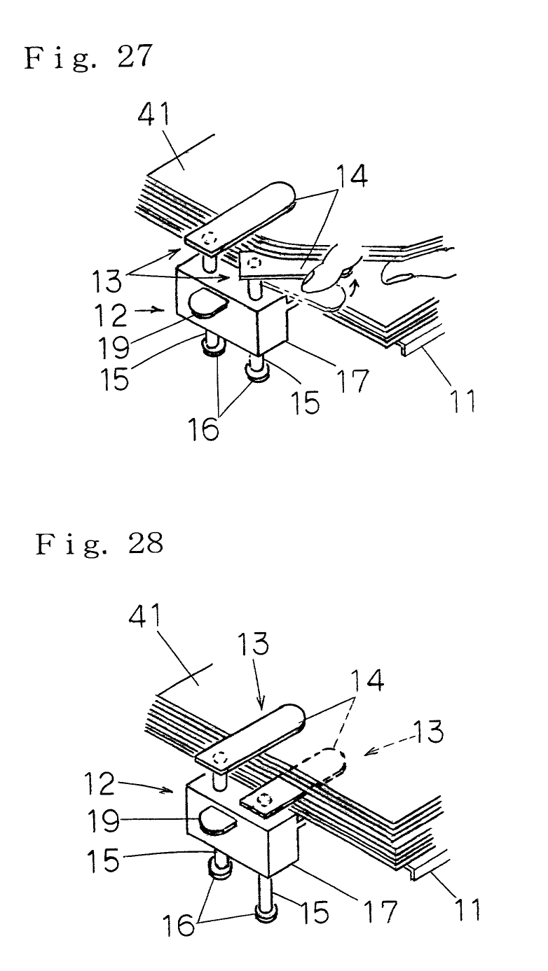

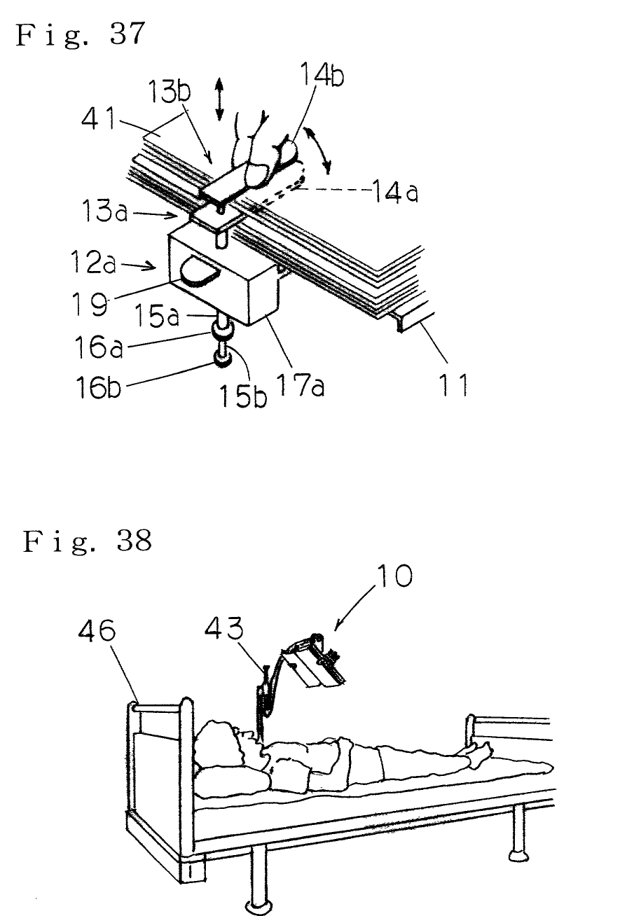

The book holder 10 having the above-mentioned constitution and the manner of operation is particularly applicable to a case that a reader reads the book B while lying on a bed in turning over as shown in FIG. 38. That is, in such an application, it is necessary to make the book holder 10 take the turn-over posture shown in FIG. 38 so that a considerable pressing force is usually applied to the page pressers 13 due to the weight of the pages. In this case, as shown in FIG. 25 and FIG. 26, first of all, the reader turns the page pressing member 14 of the page presser 13 closer to the reader in an arrow direction with his finger to remove the page pressing member 14 from the surface of the page 41. Then, as shown in FIG. 27 and the FIG. 28, the reader lifts up bottom end portions of an arbitrary number of pages and rotates again the page pressing member 14 to return the page pressing member 14 in the previous inserted position such that the page pressing member 14 is inserted between arbitrary pages as shown in FIG. 28.

In this manner, by supporting a plural number of pages using two page pressers 13 such that the load or the pressure can be distributed, it becomes possible to reduce the burden that the page pressing member 14 of the upper side page presser 13 which presses the opened page surface has to receive or support. Accordingly, the reader can easily turn each page of the book B using a single hand even lying on a bed.

FIG. 33 to FIG. 34 show the manner of manipulation of the page pressers 13 which uses the finger engaging member 19 to lift or lower the page pressers 13. In this case, as shown in FIG. 33 and FIG. 34, using the finger engaging member 19 as a fulcrum, by engaging his finger to either a lower surface of the stopper 16 mounted on the end of the support member 15 of the page presser 13, the page presser 13 can be easily lifted or lowered. In this case, the reader can also easily turn each page of the book B using a single hand even lying on a bed.

[Modification]

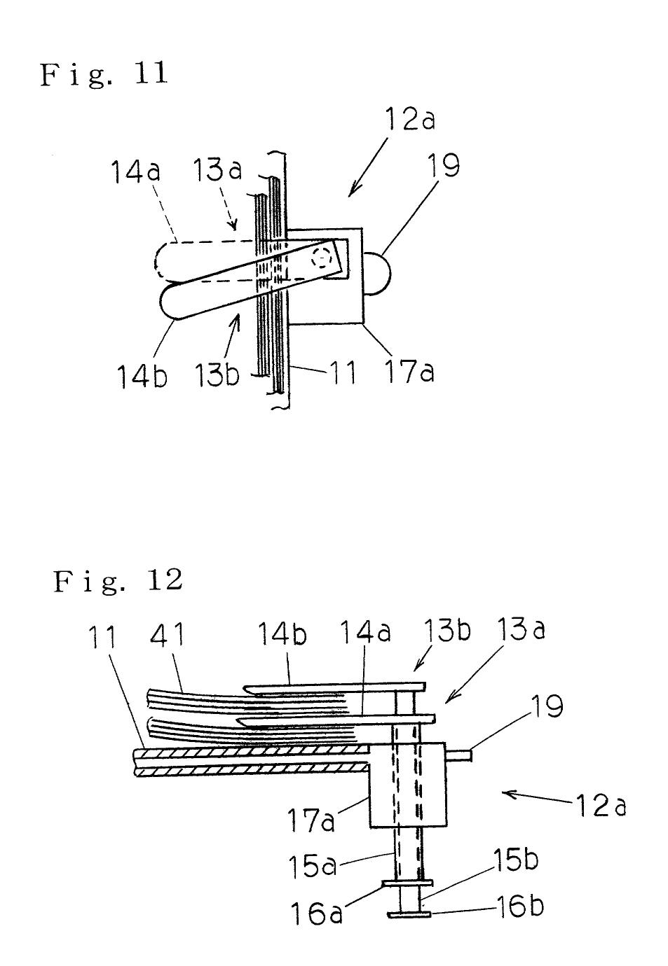

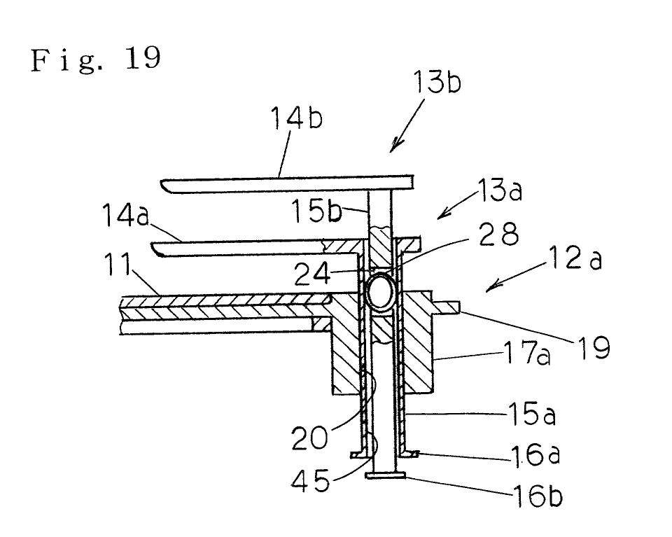

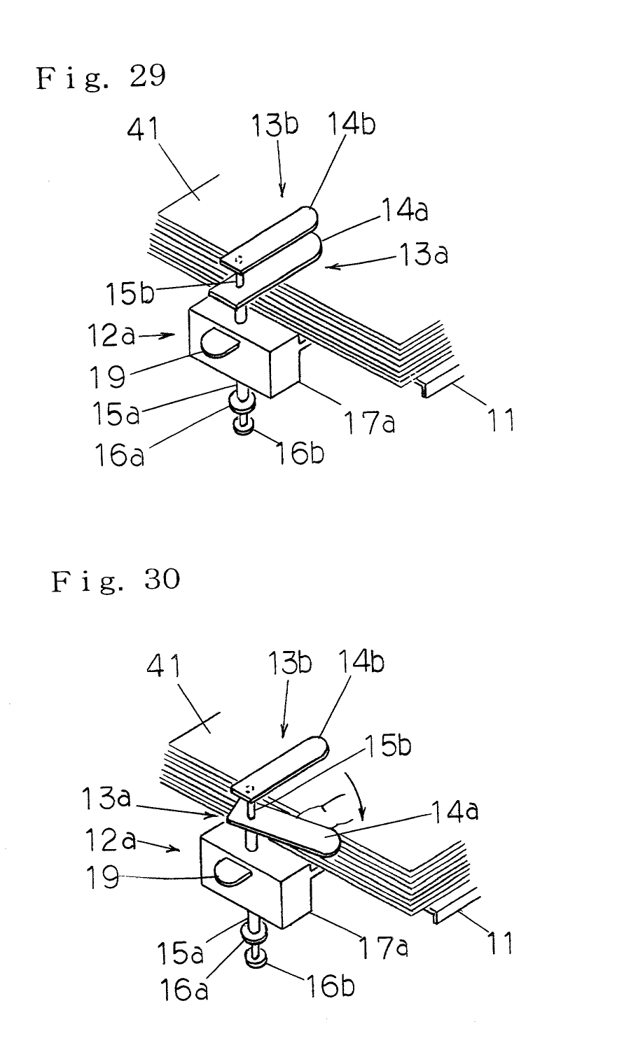

The book holder according to a modification of the embodiment is explained hereinafter in conjunction with FIG. 11 to FIG. 14, FIG. 19, FIG. 29 to FIG. 32 and FIG. 35 to FIG. 37.

As shown in FIGS. 11 and 12, at each side of a book receiving base 11 having a left and right symmetry, two page pressers 13a, 13b which have a duplicate tube structure are arranged concentrically in two stages in the vertical direction. These page pressers 13a, 13b are mounted on a page presser mounting portion 12a. In these page pressers 13a, 13b arranged in two stages, a page pressing member 14a of the lower-stage page presser 13a is inserted between a cover of a book B and a page adjacent to the cover or between arbitrary pages among a plurality of pages, and the page pressing member 14a is directed toward the central portion of the book receiving base 11 so as to make the page pressing member 14a push the surface of the page with a relatively strong force. Further, the page pressing member 14b of the upper-stage page presser 13b is extended toward the central portion of the book receiving base 11 laterally or in a slightly inclined frontward direction so as to push the surface of a page 41 with a light pressure.

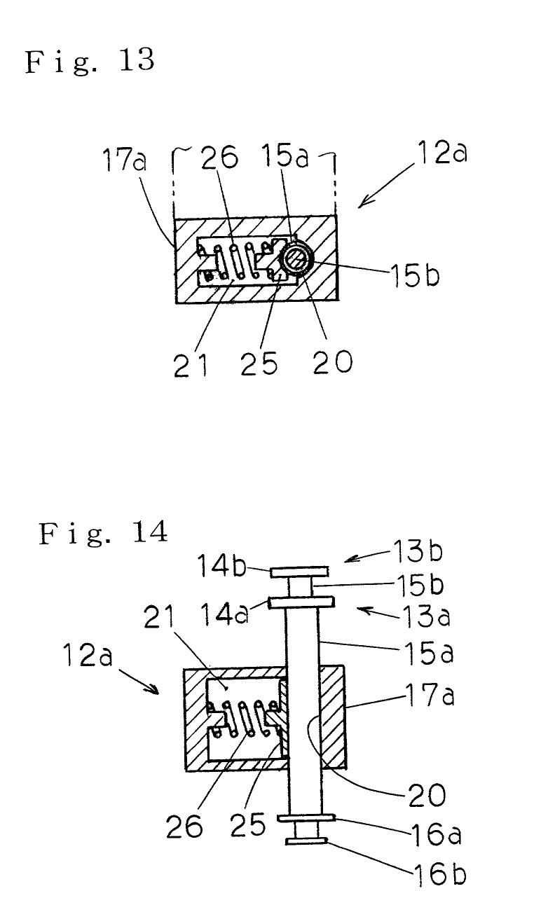

Further, according to the book holder 10 of this modification, as shown in FIG. 13 and FIG. 14, in a hole forming portion 17a of a page presser mounting portion 12a for mounting the lower-stage page presser 13a, a single hole 20 is formed in a vertical direction as a through-hole. In the inside of the hole forming portion 17a, a cavity 21 which is contiguous with the hole 20 is formed. A support member 15a of the lower-stage page presser 13a is mounted in the hole 20 such that the support member 15a passes through the hole 20. A stopper 16a having a width larger than the inner diameter of the hole 20 is fixedly mounted on a distal end of the support member 15a which passes through the hole 20. In the cavity 21 formed contiguously with the hole 20, a resistant body 25 which is brought into pressure contact with a portion of an outer periphery of the support member 15 a mounted in the hole 20 such that the support member 15a passes through the hole 20 and a biasing spring 26 are accommodated.

FIG. 19 shows a book holder of another modification. In the drawing, a hole 20 for mounting an upper page presser 13b is formed in a hole forming portion 17a of a page presser mounting portion 12a as a through hole. Then, a support member 15a of a lower-stage page presser 13a constituted by a page pressing member 14a and a support member 15a made of a hollow circular pipe is mounted in the hole 20 such that the support member 15a can be slidably inserted into or pulled out from the hole 20, can be rotated and can be fixedly held in place.

A stopper 16a having a width larger than the inner diameter of the hole 20 is fixedly mounted on the distal end of the support member 15a which passes through the hole 20. In a space defined in the support member 15a having the above mentioned hollow structure which passes through the hole 20, the support member 15b of the page presser 13b which is constituted by the page pressing member 14b and the support member 15b is inserted thus constituting the page pressers 13a, 13b having a duplicate tube structure which is comprised of the page pressing members 14a, 14b in two stages in the vertical direction.

A stopper 16b having an outer-width larger than the inner diameter of the space defined in the hollow support member 15a is fixedly mounted on the support member 15b which passes through the support member 15a. A hole 24 is formed in a portion of the bar-like support member 15b and a leaf spring 28 which is brought into pressure contact with the inner surface of the space 45 formed in the support member 15a is disposed in the hole 24.

Due to such a constitution, the upper-stage page presser 13b which is mounted in the lower-stage page presser 13a can be inserted or pulled out from the lower-stage page presser 13a and is capable of performing the relative rotation to the upper side page pressing member 13b and can be fixedly held at a desired position relative to the upper side page presser 13b.

[Manner of Operation]

The manner of operation the book holders 10 of the modifications having the duplicate tube structure is explained hereinafter.

Since the book holders 10 of the modifications are also provided with a plurality of page pressers 13a, 13b which have the constitution similar to that of the page pressers 13 of the embodiment at each side of the book receiving plate 11 so that the book can be firmly held in a page-opened state and the reader can easily turn pages while lying on a bed or the like as in the case of the embodiment.

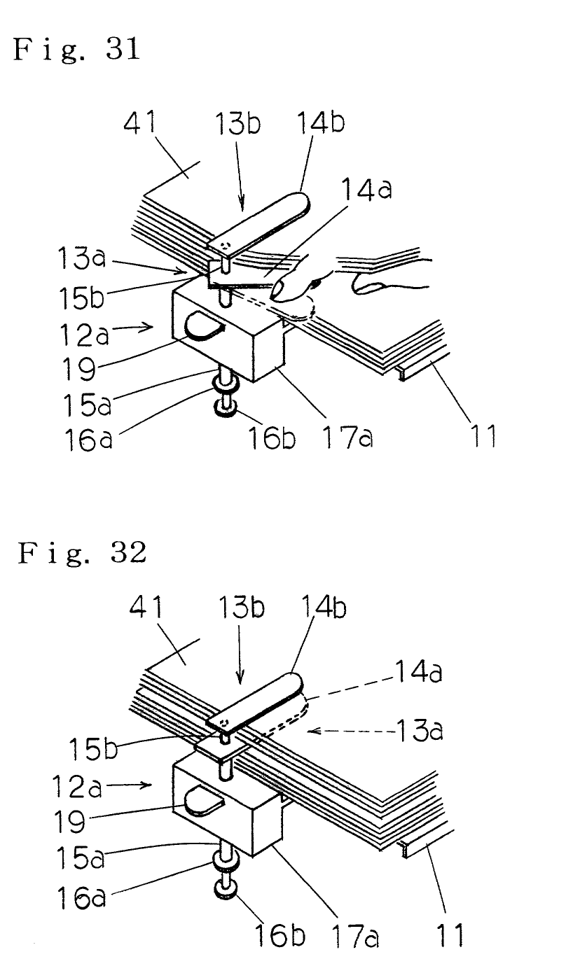

In this modification, to reduce a pressing force, first of all, as shown in FIG. 29 and FIG. 30, the page pressing member 14a of the page presser 13a closer to the reader is turned in an arrow direction with his finger to remove the page pressing member 14a from the surface of the page 41. Then, as shown in FIG. 31 and the FIG. 32, the reader lifts up bottom end portions of an arbitrary number of pages and rotates again the page pressing member 14a of the presser 13a to return the page pressing member 14a such that the page pressing member 14a is inserted between arbitrary pages as shown in FIG. 32.

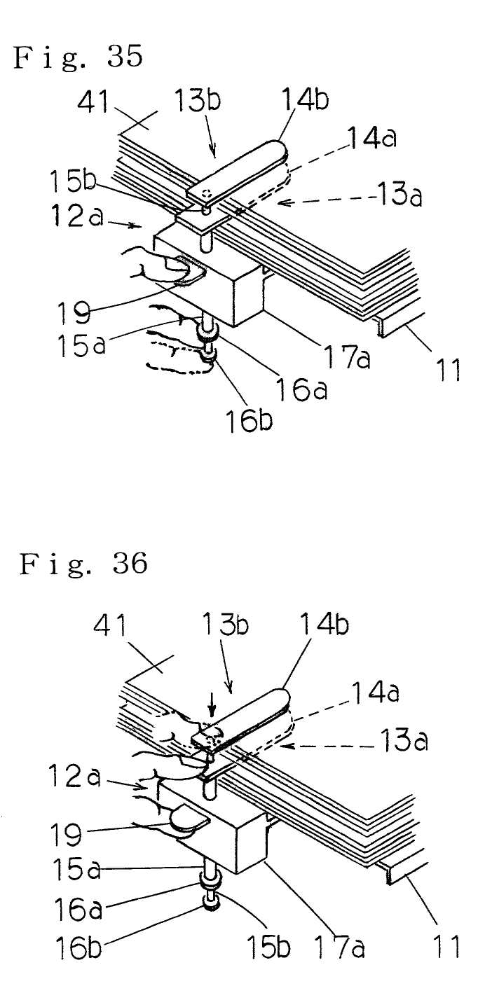

FIG. 35 and FIG. 36 show the manner of manipulation of the page pressers 13a, 13b which uses a finger engaging member 19 to lift or lower the page pressers 13a, 13b. Using the finger engaging member 19 as a fulcrum, by engaging his finger to either a lower surface of the stopper 16a,16b mounted on the end of the support member 15a, 15b of the page presser 13a,13b, the page presser 13a,13b can be easily lifted or lowered.

FIG. 37 shows another manner of operation of the book holder 10 of this modification. That is, since the retaining force of the upper-stage page presser 13b is small compared to that of the lower-stage page presser 13a (see FIG. 19), the reader can directly grip the page pressing member 14b and can lift or lower or rotate the page presser 13b.

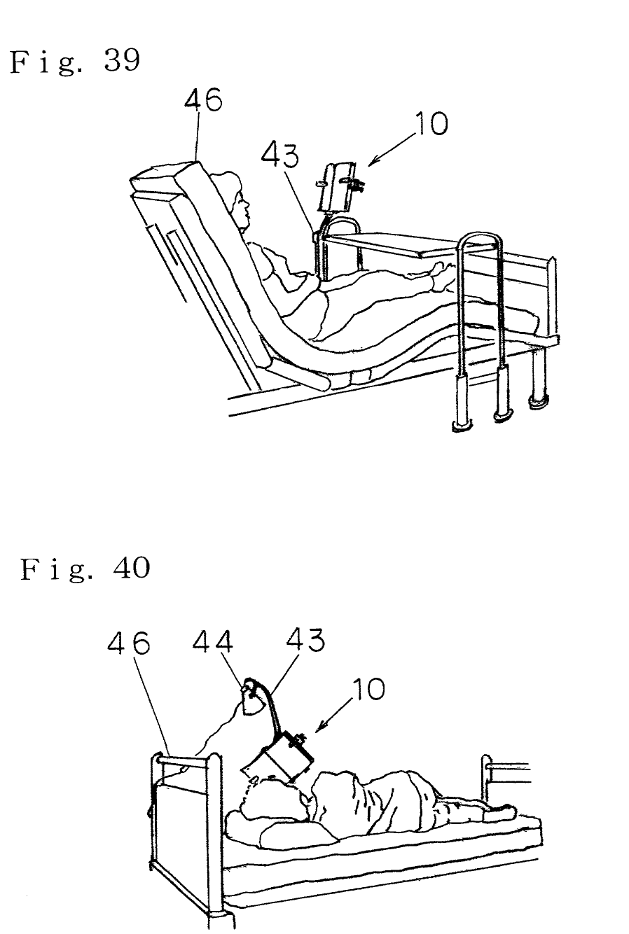

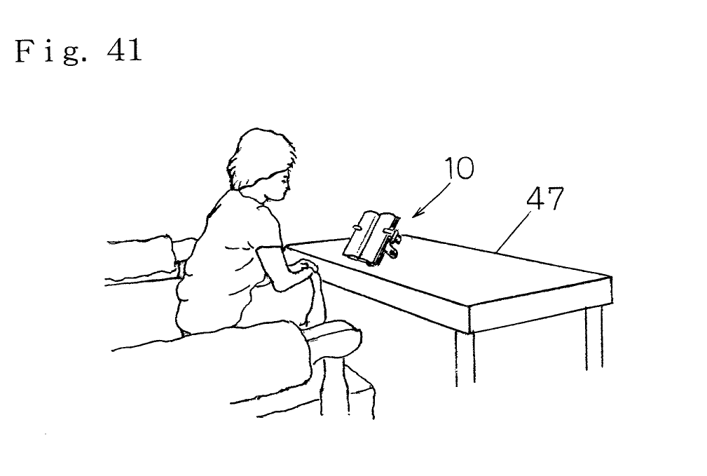

FIG. 38 to FIG. 41 show several examples to which the book holder 10 of the present invention is applicable. In FIG. 38 to FIG. 40, the book holder 10 on which the book is fixed is mounted on a stand 43 stood close to a bed 46 in such a manner that the posture of the book can be adjusted. In FIG. 40, numeral 44 indicates a lighting equipment. In FIG. 41, the book holder 10 is directly placed on a table 47. It is needless to say that the book holder 10 can be directly mounted on a bed frame or can be directly placed on a desk although not shown in the drawing.

As has been described heretofore, according to the present invention, following effects can be obtained.

(1) With the provision of a plurality of page pressers at each side of the book holder, a repulsive force of the page and the weight of the pages which act to make the page move in a closing direction when the book holder is used by a reader in the turning over posture can be supported in a distributed manner. Accordingly, the book can be firmly mounted on the book holder and simultaneously the pressing force can be easily adjusted so that the turning of the page can be easily performed in a following manner.

That is, a sheet of page is pinched by fingers and is pulled out from one page inserting gap defined between the page pressing member and the book receiving base toward the reader and toward the center of the book receiving base. Then, the pulled-out page is inserted into the other page inserting gap.

In such an operation, conventionally, when the face pressure between the page surface and the page pressing member is excessively strong, the frictional force between the page pressing member and the surface of the page to be pulled out as well as the frictional force between the surface of the page to be pulled out and the surface of a page below the page to be pulled out are increased so that a large force becomes necessary to pull out the page to be pulled out. Further, the page below the page to be pulled out is pulled out together with the page to be pulled out. Further, the insertion of the pulled-out page into the right page inserting gap also becomes difficult due to the above-mentioned reason. To the contrary, according to this embodiment, with the use of a plurality of page pressers arranged at each side of the book receiving base, the pressing force applied to the opened pages can be reduced as small as possible so that the opened page can be easily pulled out from one page inserting gap and can be easily inserted into the other inserting gap whereby the page turning operation is facilitated.

When the page turning operation is continued and the number of pages is reduced at one page inserting gap, the pressing pressure which presses the opened page becomes small. When this pressing pressure becomes excessively small, the page is liable to be easily removed from the page pressing member. Particularly, when the surface of the opened page is in an arcuate shape, the opened page is more liable to be easily removed from the page pressing member. In such a case, the page pressing member is pushed down to adjust the pressing pressure.

Then, when the page turning operation is further continued, no page remains between upper-side page pressing member which presses the surface of opened page and the lower-side page pressing member. In such a case, the lower-side page pressing member is rotated to position this page pressing member out of the page surface. Here, although the pages which have been pressed by the lower-side page pressing member are now moved in a page-closing direction, because of the presence of the upper-side page pressing member, these pages are received by the upper-side page pressing member. Then, after opening edges of several or several tens pages with a finger, the lower-side page pressing member is again inserted between arbitrary pages. After inserting the lower-side page pressing member, the upper-side page pressing member is pushed so as to make the page pressing member firmly hold the pages. Such operations are repeated.

On the other hand, to insert the pulled-out page into a space defined between the upper and lower page pressing members, as the number of pages disposed in the space is gradually increased, it becomes difficult to insert the pulled-out page. Accordingly, each time the insertion of the pulled-out page becomes difficult, the page presser is pulled out or pushed out from the hole to adjust the pressing pressure. Then, when such an adjustment becomes difficult due to the repulsive force acting on the pages to close the pages and the weight of the pages both of which are increased corresponding to the increase of the number of inserted pages, the lower-side page pressing member inserted between the intermediate pages is rotated outwardly to position the lower-side page pressing member out of the page surface. In this case, since the pages which have been received by the lower-side page pressing member are now received by the upper-side page pressing member so that the pages are not closed. Then, the lower-side page member is slightly pulled out or pushed out and then is returned to the upper surface of the opened page and presses the opened page. Thereafter, the upper-side page pressing member is slightly pulled out to forma slight gap between the upper-side pressing member and the lower-side pressing member so as to adjust the gap such that the turned page can be easily inserted. Such operations are repeated.

In the above-mentioned manner, the pages can be easily and surely turned one by one.

(2) In the present invention, the page presser mounting portions provided for mounting the page pressers are arranged at left and right sides of the book receiving base and these page presser mounting portions are made slidable in a laterally outward direction to the left and the right from the central portion of the book receiving base and are fixed in place. In this manner, without increasing the size of the outer contour of the book receiving base, the book holder can perform the page pressing even when the book is of a considerably large size so that the book receiving base having a compact outer shape in the lateral direction can be obtained.

(3) With respect to a plurality of page pressers respectively mounted on left and right sides of the book holder, in the constitution in which two page pressers having the single rod structure are mounted on each side, an opened page can be lightly pressed using one of two press members and the other one of two press members can be inserted between arbitrary pages interposed between the opened page and the cover so as to strongly press the surface of the page disposed below the press member.

(4) With respect to a plurality of page pressers respectively mounted on left and right sides of the book holder, in the constitution in which two page pressers being arranged in two stages vertically thus constituting a duplicate tube structure are mounted on each side, an opened page can be pressed with a light pressure using the upper-stage press member and the lower-stage press members can be inserted between arbitrary pages interposed between the opened page and the cover so as to strongly press the surface of the page disposed below the press member.

(5) With the provision of a plurality of page pressers at each side of the book holder, by adjusting the number of pages disposed between the opened page and the page presser inserted in the page intermediate portion, the pressing force which presses the opened page can be decreased so that the page can be easily turned. That is, the smaller the number of pages, it becomes easier to press the pages with a smaller pressing force. Further, by inserting the page pressing member into the page intermediate portion and strongly pressing the other (lower) page, the burden that the upper-side pressing member has to bear can be alleviated.

(6) Further, according to the present invention, the hole which rotatably and slidably mounts the support member of the page presser therein is formed in the page presser mounting portion and the cavity which is communicable with the hole is formed in the page pressing mounting portion. In the inside of the cavity, the resistant body which is brought into contact with a portion of the circumferential periphery of the support member and the biasing spring or the leaf spring or the like are disposed. In such a constitution, due to the biasing pressure of the spring, the frictional resistance is generated at a contact portion between the support member and the resistant body so that the retaining force which fixes the support member is generated. Accordingly, with the use of an elastic body having a large friction resistance as the resistant body and the spring having a strong biasing force, the large retaining force can be obtained. Further, the stopper element is formed on the end portion of the support member so as to prevent the support member from being removed from the hole.

(7) In the page presser mounted on the page presser mounting portion and having a duplicate tube structure made of the support members of the upper and lower-stage page pressers, the slit is formed in a portion of the support member of upper-stage page presser and the pressure contact element made of the resilient body such as the steel-made spring or rubber is mounted in the slit and is brought into pressure contact with the inner surface of the lower-stage hollow support member. In such a constitution, due to the pressure contact resistance generated between the pressure contact element and the inner surface of the lower-stage support member of the pressing member, the upper-stage support member can be mounted in the hole such that the support member is rotatable and slidable relative to the lower-stage support member. Accordingly, the pressing force which presses the opened page can be reduced to a small value so that the page presser having a duplicate tube constitution constitutes a structure suitable for the operation in small pressing pressure. Further, since a stopper element is mounted on the distal end of the upper-stage support member which passes through the lower-stage support member, the removal of the lower-stage support member is prevented. Further, since the page presser has a duplicate tube structure in two stages in a vertical direction, the page presser can be formed into a compact constitution.

(8) At the bottom side of the central portion of the book holder, the bottom side stopper which has a raised portion is formed. The threaded pin is mounted on the central portion of the bottom stopper such that the threaded pin is slidable in the vertical direction. In mounting the book on the book holder, the book which is opened at the intermediate portion of the pages is placed on the book receiving base. The threaded pin is sandwiched by the binding portion disposed at the central portion of the pages and then the threaded pin is pushed down with some force so as to press the binding portion with the threaded pin whereby the book is firmly mounted on the book holder. In this manner, by making the threaded pin slide in the vertical direction, the threaded pin can cope with the thickness of the book and the pin can be easily inserted between the pages at the time of mounting the book. Particularly, with respect to the book holder having the recessed portion at the central portion thereof, when the book having the thick or hard cover is mounted, since the binding portion of the book does not come into contact with (sunk into) the recessed portion, to sandwich the threaded pin at the binding portion, it is necessary to position the pin at a position above the binding portion in a vertical direction. According to the present invention, coupled with the threaded pin provided to the top stopper, the threaded pin can prevent the displacement of the book in the lateral direction as well as in the longitudinal direction and the fall of the book at the time of using the book holder having its book receiving surface in a turned-over posture.

(9) Further, an L-shaped top slide stopper is slidably mounted on the top side of the central portion of the book holder. In the L-shaped raised portion of the top slide stopper, the threaded pin which is slidable in the vertical direction. Accordingly, a book of any thickness can be firmly mounted on the book receiving plate using such slidable pins.

What is claimed is:

1. A book holder comprising
a book receiving base forming a book mounting surface on an upper surface thereof,
a pair of left and right page presser mounting portions which are respectively arranged at left and right side peripheral portions of said book receiving base, said each page presser mounting portion having a support member insertion hole extending in the vertical direction formed therein,
a bottom stopper for supporting a bottom of a book being mounted on a bottom portion of said book receiving base, said bottom stopper having a pin extending toward a top of said book receiving base at a central portion of said book receiving base,
a pair of left and right page pressers mounted on said book receiving base in a substantially left-and-right symmetry, said each page presser comprising a support member which is inserted into said support member insertion hole slidably in a vertical direction and rotatably and a page pressing member which has one end connected to an upper end of said support member and the other end extended toward a central portion of said book receiving base parallel with said book mounting surface of said book receiving base, and
fixing means for fixing said support members of said left and right page presser at arbitrary positions in said holes,
the improvement being characterized in that a plurality of said page pressers are provided to each side of said book receiving base and said support members of a plurality of said page pressers at each side are inserted in said support member inserting hole such that said support members are vertically slidable and rotatable independently from each other.

2. A book holder according to claim 1, wherein a plurality of said page pressers arranged at each side of said book receiving base are constituted by two page pressers, said support member inserting hole is constituted by two support member inserting holes, and said support members of said two page pressers are respectively slidably and rotatably inserted into said two support member inserting holes.

3. A book holder according to claim 1, wherein a plurality of said page pressers mounted on each side of said book receiving base are constituted by two page pressers, said support member inserting hole is constituted by a single support member inserting hole, said support members of said two page pressers form a concentric duplicate tube structure and said duplicate tube structure is slidably and rotatably inserted into said single support member inserting hole, and said two support members are slidable and rotatable from each other.

4. A book holder according to claim 1, wherein both of a pair of said left and right page presser mounting portions which are respectively arranged at left and right side portions of said book receiving base are slidable relative to said book receiving base in a lateral direction.

5. A book holder according to claim 2, wherein a cavity which is communicable with said support member inserting hole is formed in said each page presser mounting portion and resistant bodies and a biasing spring which resiliently brings said resistant bodies into slide contact with said support members of said page presser are accommodated in said cavity.

6. A book holder according to claim 3, wherein in said duplicate tube structure, one of said support members is made of a rod and the other is made of a tube which concentrically surrounds said rod, a slit is formed in said rod, and a pressure contact element having a diameter larger than an outer diameter of said rod is disposed in said slid and is brought into pressure contact with an inner surface of said tube.

7. A book holder according to claim 3, wherein said pin mounted on said bottom stopper is slidable in a direction toward or away from said book receiving surface of said book receiving base so as to adjust a height thereof from said book receiving surface.

8. A book holder according to claim 3, wherein a top stopper is provided to a top central portion of said book receiving base, said top stopper is slidable relative to said book receiving base in a direction toward or away from said bottom stopper, and a pin is mounted on said top stopper such that said pin is slidable in a direction toward or away from said book receiving surface of said book receiving base so as to adjust a height thereof from said book receiving surface.

9. A book holder according to claim 1, wherein a finger engaging tab is formed on an outer side of said each page presser mounting portion.

10. A book holder according to claim 1, wherein at least a portion of said each page pressing member is made of a transparent material.
